(19) United States
(12) Patent Application Publication
(10) Pub. No.: US 2025/0199739 A1
(43) Pub. Date: Jun. 19, 2025

(54) IMAGE FORMING APPARATUS AND IMAGE FORMING METHOD

(71) Applicant: SHARP KABUSHIKI KAISHA, Sakai City (JP)

(72) Inventor: MASAFUMI OKIGAMI, Sakai City (JP)

(21) Appl. No.: 18/978,267

(22) Filed: Dec. 12, 2024

(30) Foreign Application Priority Data
Dec. 15, 2023 (JP) 2023-212313

(51) Int. Cl. G06F 3/12

(52) U.S. Cl. CPC G06F 3/1267; G06F 3/1221; G06F 3/1229; G06F 3/1263

(57) ABSTRACT

An image forming apparatus comprises a printer that performs printing; a job receiver that receives a print job to be performed using the printer; a data storage that stores the print job when the print job is externally received in a power saving mode that is a state in which power consumption is less than a normal mode that is a state in which the printing is executable; and one or more controllers that execute the print job after entering the normal mode from the power saving mode when one or both of reach of a planned timing and storage of at least a predetermined number of the print jobs in the data storage is satisfied, as a predetermined print execution condition.

### CROSS-REFERENCE TO RELATED APPLICATION

The present application claims priority from Japanese Application JP2023-212313, the content of which is hereby incorporated by reference into this application.

### BACKGROUND

### 1. Field

The present disclosure relates to an image forming apparatus and an image forming method capable of executing printing after a normal mode is entered, when a predetermined condition is satisfied in a state in which data on a print job received in a power saving mode is stored.

### 2. Description of the Related Art

A print apparatus configured as follows is known. That is, when processing data on print jobs received in a power saving mode so that print data is generated and stored in a memory, and thereafter, satisfying a preset print condition, the print apparatus cancels the power saving mode to enter a normal mode and collectively prints the print data. Note that, in the power saving mode, power consumption is suppressed compared to the normal mode in which the print apparatus can immediately execute printing. In the power saving mode, in order to reduce power consumption, power supply to units having large power consumption, such as a fusing unit and a display unit, is stopped or reduced, and thus printing and other functions are restricted. When performing printing, the print apparatus cancels the power saving mode and returns to the normal mode.

The print apparatus spools received print jobs in a spooling section (24). A schedule section (25) outputs the print job according to priority indicating the order of output of the spooled print jobs. Furthermore, the user sets and changes the priority (order of output) in accordance with a priority processing instruction made on a print job queue screen. Upon receiving a print job, the print apparatus generates print data, stores the print data in the memory, adds the received print job to a print job queue on an operation panel, and displays the print job.

When the user operates a power saving cancel button on the operation panel or an operation screen of a host computer so as to cancel the power saving mode, or when the user selects one or more print jobs on a display screen of the print job queue so as to issue priority processing instruction, the print apparatus cancels the power saving mode and performs a return process to enter the normal mode. Then, print jobs subjected to the priority processing or having priority levels equal to or higher than a predetermined level are collectively printed. Therefore, a print job having a low priority is printed by being instructed to be preferentially processed by the user from the print job queue. On the other hand, when receiving a print job having a high priority level, the print apparatus cancels the power saving mode, performs the return process, and thereafter, enters the normal mode. Then print jobs subjected to the priority processing or having priority levels equal to or higher than a predetermined level are collectively printed. In this way, a power saving time longer than in the case where printing is performed after canceling the power-saving mode each time a print job is received can be ensured, and required printed matter can be collectively acquired when necessary.

Furthermore, a print apparatus that has a plurality of mode setting tables for setting a time zone in which switching from a powered mode to a power saving mode is prohibited and that can select an appropriate one of the mode setting tables based on a use condition of the apparatus is known. An appropriate mode setting table for an operation mode of the user is generated and a switching between the powered mode and the power saving mode is selectively performed so that printing is accelerated and power saving is attained.

### SUMMARY

However, to output a print job of a low priority level, the user is required to perform an operation of a priority processing instruction on a display screen of a print job queue after transmitting the print job. Although the print job queue screen is operated only once when a plurality of print jobs are to be collectively printed, the print job queue screen is required to be displayed to perform the operation of the priority processing instruction every time a print operation is performed, and therefore, the operation is troublesome. Furthermore, the operation of the priority processing instruction is troublesome since a desired print job is required to be retrieved from among print jobs of low priority levels in a job queue. However, when the print job is set to have a high priority level in order to avoid the complication, this method is not different from the general methods of canceling a power saving mode every time a print job is received. In a case where a power saving prohibition time zone in which switching from the powered mode to the power saving mode is prohibited is designated, a powered state is maintained and power consumption may increase even after printing is finished in the power saving prohibition time zone. The present disclosure has been made in view of the circumstances described above, and therefore, provides a method for ensuring a period in the power saving mode for reducing power consumption even in an environment in which print jobs are frequently executed.

According to an aspect of the present disclosure, an image forming apparatus includes a printer that performs printing, a job receiver that receives a print job to be performed using the printer, a data storage that stores the print job when the print job is externally received in a power saving mode, and one or more controllers that execute the print job after entering a normal mode from the power saving mode when at least one of predetermined print execution conditions, that is, reach of a planned timing and storage of at least a predetermined number of print jobs in the data storage, is satisfied.

According to another aspect of the present disclosure, an image forming method is employed in a processor controlling an image forming apparatus. The processor includes receiving at least a print job for performing printing, storing the print job in a data storage when the print job is externally received in a power saving mode, and executing the print job after entering the normal mode from the power saving mode when at least one of predetermined print execution conditions, that is, reach of a planned timing and storage of at least a predetermined number of print jobs in the data storage, is satisfied.

Since the image forming apparatus according to the present disclosure includes a data storage that stores the print job when the print job is externally received in the power saving mode, and one or more controllers that execute the print job after entering the normal mode from the power saving mode when at least one of predetermined print execution conditions, that is, reach of a planned timing and storage of at least a predetermined number of print jobs in the data storage, is satisfied, a period of time for the power saving mode can be ensured even in an environment in which print jobs are frequently executed, and accordingly, power consumption can be reduced. The image forming method according to the present disclosure also achieves similar advantageous effects.

### BRIEF DESCRIPTION OF THE DRAWINGS

FIG. 1 is a perspective view of appearance of a multifunction peripheral as a mode of an image forming apparatus according to the present disclosure.

FIG. 2 is a block diagram illustrating a configuration of the multifunction peripheral illustrated in FIG. 1.

FIG. 3 is an explanatory diagram illustrating an example of an operation of storing, when a print job is received in a power saving mode, the print job in a data storage, and executing the print job when a print execution condition is satisfied, according to the first embodiment.

FIG. 4 is an explanatory diagram illustrating an example of a process performed when the data storage does not store any print job when the print execution condition is satisfied, according to a second embodiment.

FIG. 5 is an explanatory diagram illustrating an example of a process of additionally executing, when a copy job is executed, a print job stored in a data storage, according to a third embodiment.

FIG. 6 is an explanatory diagram illustrating an example of a process of additionally executing, when a print job of a high priority level is executed, a print job of a low priority level stored in a data storage, according to a fourth embodiment.

FIG. 7 is a first flowchart illustrating an example of a flow of a process executed by a controller according to the mode.

FIG. 8 is a second flowchart illustrating an example of a flow of a process executed by the controller according to the mode.

### DESCRIPTION OF EMBODIMENTS

Hereinafter, the present disclosure will be described in more detail with reference to the accompanying drawings. Note that the following description is illustrative in all respects and should not be construed as limiting the present disclosure.

### Configuration of Image Forming Apparatus

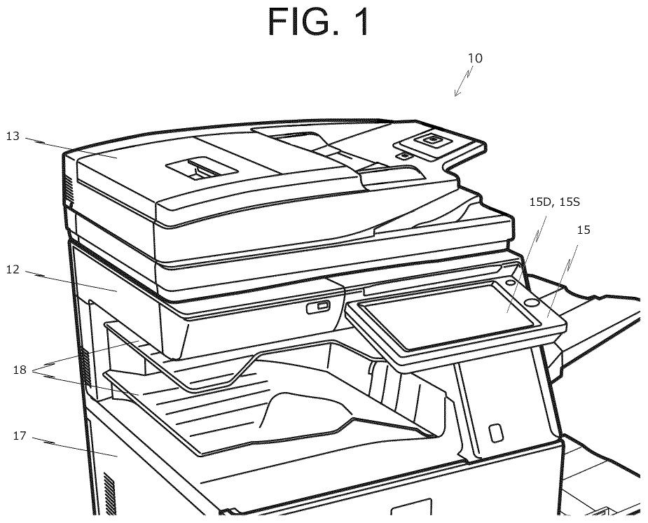

FIG. 1 is a perspective view illustrating appearance of a multifunction peripheral as a mode of an image forming apparatus in a portion in the vicinity of a document reader and an operation acceptor.

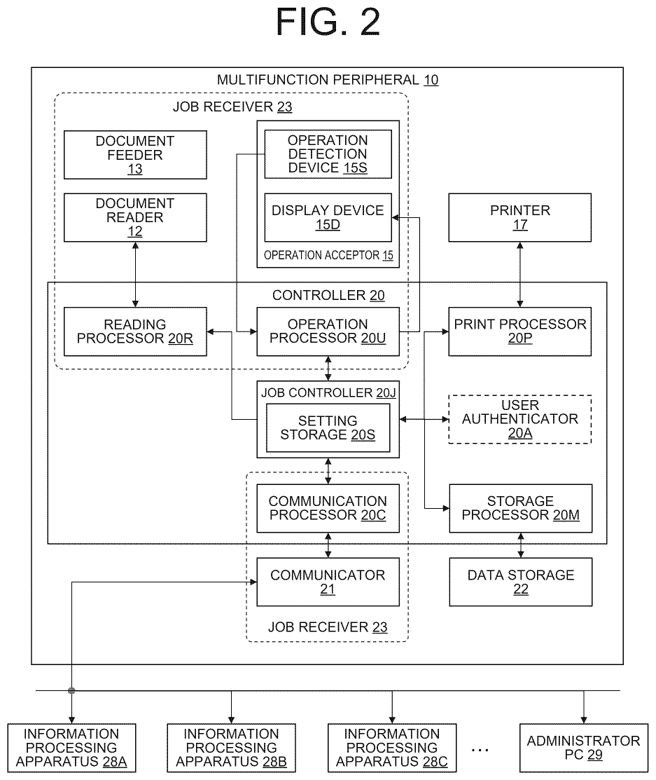

As illustrated in FIG. 2, a multifunction peripheral 10 is connected to external information processing apparatuses through a network. The multifunction peripheral 10 includes a document reader 12 that reads a document image and a document feeder 13. The document reader 12 includes, inside thereof, a scanning mechanism, an image sensor, and a signal processing circuit that processes signals supplied from the image sensor. A document placed on a transparent platen is scanned using the scanning mechanism, and a lower surface of the document is read by the image sensor and processed by an image processing circuit so that image data is generated. Furthermore, the document feeder 13 conveys set documents one by one to the document reader 12. The document reader 12 reads lower surfaces of the documents that pass the document reader 12 so as to generate image data. The document feeder 13 has a front side that can be opened upward with a hinge, not illustrated, located in a depth side in the perspective view of FIG. 1, and includes the platen (not illustrated in FIG. 1), on an upper surface of the opened document reader 12, for reading a thick document, such as a book, by scanning the thick document by the scanning mechanism. Furthermore, on the upper surface of the document reader 12, a reader for reading a document transported by the document feeder 13 is disposed.

The multifunction peripheral 10 includes an operation acceptor 15 on a front side relative to the document reader 12. The operation acceptor 15 includes a display device 15D using a liquid crystal display, for example, and an operation detection device 15S, such as a transparent panel, disposed on the display device 15D. Furthermore, as illustrated in FIG. 1, a printer 17 is disposed below the document reader 12, and forms an image based on image data read by the document reader 12 or print data received from an external information processing apparatus, and prints the image on a print sheet. The printing is executed by, for example, a known electrophotographic method. Therefore, the printer 17 includes a photosensitive drum, a charging device, an exposing device, a developing device, a transferring device, a fusing device, a cleaning device, and a discharging device, not illustrated. The printer 17 is not limited to the one employing the electrophotographic method, and may be the one for executing an image forming process by an ink jet method, for example. The printer 17 transfers the formed image to a print sheet transported from a paper feed tray, not illustrated. The printer 17 further transports the print sheet on which the image has been transferred, and guides the print sheet to one of two sheet discharge trays 18.

FIG. 2 is a block diagram illustrating a configuration of the multifunction peripheral 10 illustrated in FIG. 1. As illustrated in FIG. 2, the multifunction peripheral 10 includes a controller 20, a communicator 21, and a data storage 22 in addition to the document reader 12, the operation acceptor 15, and the printer 17. The controller 20 is an example of a control section that controls the entire multifunction peripheral 10. Therefore, the controller 20 includes a processor as a control executor of the multifunction peripheral 10. In addition, the controller 20 includes a memory which is accessible by the processor. The memory may include a read only memory (ROM) and a random access memory (RAM). The ROM may store a control program to be executed by the processor. Furthermore, the RAM may provide a work area and a buffer area which are used when the processor executes processing based on the control program. A hardware source of the controller 20 mainly including the processor and the memory and software of the control program are organically combined to each other to implement a function of the controller 20.

As illustrated in FIG. 2, the controller 20 includes a reading processor 20R, an operation processor 20U, a print processor 20P, a job controller 20J, a communication processor 20C, and a storage processor 20M. The controller 20 may further include a user authenticator 20A. The reading processor 20R controls the document reader 12 to perform processing associated with document reading. The operation processor 20U controls the operation acceptor 15 to perform processing associated with display of operation information and detection of an operation. These components cooperate with each other to provide a print job, such as copying, using the operation acceptor 15. From this point of view, the document reader 12, the operation acceptor 15, the reading processor 20R, and the operation processor 20U can be regarded as a job receiver 23 that receives a print job to be executed from a walk-up user (refer to a portion surrounded by a chain line frame in FIG. 2).

Furthermore, the print processor 20P controls the printer 17 to perform processing associated with printing. The communication processor 20C controls the communicator 21 to perform data communication. For example, when a print job is received from an information processing apparatus 28A, the communicator 21 and the communication processor 20C are regarded as the job receiver 23 (refer to a portion surrounded by a chain line frame in FIG. 2).

The job controller 20J illustrated in FIG. 2 controls the reading processor 20R, the operation processor 20U, the print processor 20P, the communication processor 20C, and the storage processor 20M to control execution of jobs including a print job. Furthermore, the arbitrary user authenticator 20A performs processing associated with user authentication for a user who instructs the multifunction peripheral 10 to execute jobs including a print job. The job controller 20J includes a setting storage 20S. The setting storage 20S stores settings of conditions (print execution conditions) for executing a print job stored in the data storage 22 so that the job controller 20J can refer to the settings. The print execution conditions may be set by a user having an administrator authority using the operation acceptor 15. Alternatively, the print execution conditions may be set by an administrator PC 29 connected through the communicator 21. The user authenticator 20A may authenticate a user having an administrator authority when the settings of the print execution conditions are received.

The multifunction peripheral 10 in this embodiment includes the data storage 22. A hard disk drive or a solid state drive (SSD) is used as the data storage 22, which has a larger capacity than a main storage device included in the controller 20. The data storage 22 stores print jobs received from external apparatuses. Furthermore, the data storage 22 may store the settings accepted by the operation acceptor 15 and image data of documents read by the document reader 12 for a copy job. Examples of the external apparatuses include the information processing apparatus 28A and information processing apparatuses 28B and 28C, such as a personal computer (PC) and a smartphone.

The communicator 21 is a circuit for communication with the external information processing apparatuses 28A to 28C, an administrator PC 29, and the like connected via the network. As illustrated in FIG. 2, the multifunction peripheral 10 receives data associated with print jobs from the external information processing apparatuses 28A to 28C and the like connected via the network. The communicator 21 receives the settings of the print execution conditions from the administrator PC 29 and stores the received settings in the setting storage 20S. The communicator 21 may further transmit image data of documents read by the document reader 12 as a scanner job of the multifunction peripheral 10 to the information processing apparatus 28B and the information processing apparatus 28C, for example. In the above, the configuration of the multifunction peripheral 10 according to this embodiment has been described. Hereinafter, several embodiments of a print job controlled by the job controller 20J of the multifunction peripheral 10 will be described.

### First Embodiment

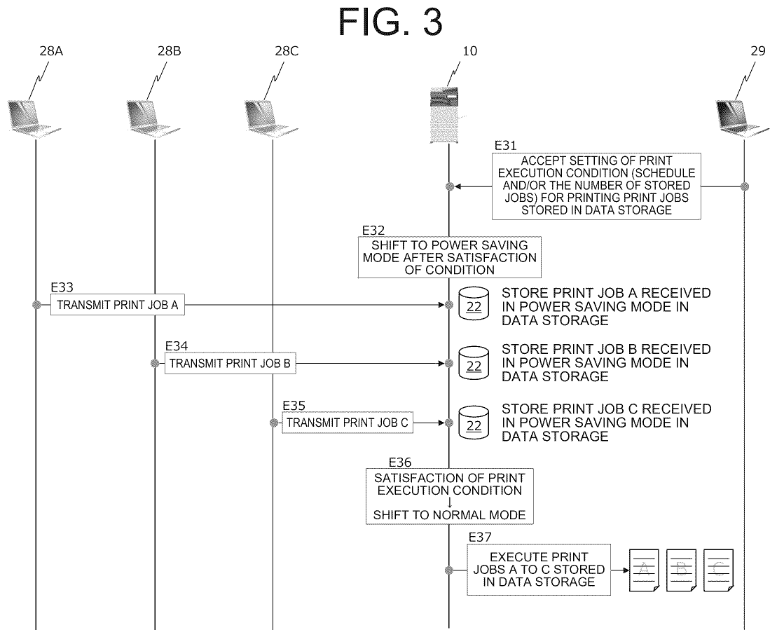

In this embodiment, the job controller 20J stores a print job in the data storage 22 when the print job is received from an external apparatus in a power saving mode and executes the print job stored in the data storage 22 when any one of the print execution conditions is satisfied. FIG. 3 is an explanatory diagram illustrating an example of a process of storing, when a print job is received in the power saving mode, the print job in the data storage 22, and executing the print job stored in the data storage 22 when any one of the print execution conditions is satisfied, according to this embodiment. In FIG. 3, the information processing apparatuses 28A to 28C are external information processing apparatuses which are communication available with the multifunction peripheral 10 through the communicator 21. The information processing apparatuses 28A to 28C transmit print jobs to the multifunction peripheral 10. The administrator PC 29 is an information processing apparatus which is similarly capable of communicating with the multifunction peripheral 10 through the communicator 21. The administrator PC 29 is used by the user who has an administrator authority to perform settings on the multifunction peripheral 10. The settings performed using the administrator PC 29 are stored in the setting storage 20S. Note that the administrator PC 29 may transmit not only the settings of the print execution conditions but also print jobs to the multifunction peripheral 10 similarly to the information processing apparatuses 28A to 28C.

In FIG. 3, rectangular frames individually indicate generated events, and the events are arranged in a time series manner from top to bottom in FIG. 3. The events will be described in the time series manner. First, when receiving settings associated with print execution conditions of a print job stored in the data storage 22 from the administrator PC 29, the job controller 20J accepts and stores the settings in the setting storage 20S. Specifically, a setting of a schedule for executing the stored print jobs and/or a setting of a threshold value for the number of print jobs stored in the data storage as a trigger to execute the print jobs are accepted (event E31 in FIG. 3). As an example, it is assumed that the setting of the schedule is to execute a print job every 30 minutes and the setting of the threshold value for the number of print jobs is 3.

Thereafter, when a condition for shift to the power saving mode is satisfied, the job controller 20J causes the multifunction peripheral 10 to enter the power saving mode (E32). When a print job A is transmitted from the information processing apparatus 28A (E33), the communicator 21 receives the print job A as the job receiver 23. The job controller 20J stores the print job A received in the power saving mode in the data storage 22. When a print job B is transmitted from the information processing apparatus 28B (E34), the communicator 21 receives the print job B as the job receiver 23. The job controller 20J stores the print job B received in the power saving mode in the data storage 22. Furthermore, in the example illustrated in FIG. 3, when a print job C is transmitted from the information processing apparatus 28C (E35), the communicator 21 receives the print job C as the job receiver 23. The job controller 20J stores the print job C received in the power saving mode in the data storage 22. In this example, the three jobs, that is, the print jobs A to C, received in the power saving mode are stored in the data storage 22.

In this embodiment, the job controller 20J monitors whether one of one or more return conditions determined in advance as the conditions for shift from the power saving mode to the normal mode is satisfied. However, not limited to the processing of the job controller 20J, the satisfaction of the return condition may be configured by hardware, may be configured using a processor different from the controller 20, or may be configured by a combination thereof. For example, an operation on a predetermined operation switch disposed in the operation acceptor 15 may be detected by hardware or software, and the job controller 20J may be configured to return from the power saving mode to the normal mode using the operation as a return condition. Alternatively, for example, a setting of a document in the document feeder 13 may be detected by hardware or software, and the job controller 20J may be configured to return from the power saving mode to the normal mode using the setting as a return condition.

In this embodiment, the print execution condition for executing a print job which is received in the power saving mode and stored in the data storage 22 is one of return conditions.

Specifically, it is assumed that, as an example of the print execution condition for executing a print job stored in the data storage 22 in the power saving mode, a schedule for executing the print job is set. When a scheduled timing is reached, the job controller 20J cancels the power saving mode of the multifunction peripheral 10 so that the multifunction peripheral 10 enters the normal mode. For example, in a case where a set schedule corresponds to execution of a print job every 30 minutes, when a scheduled timing is reached, the job controller 20J cancels the power saving mode of the multifunction peripheral 10 so that the multifunction peripheral 10 enters the normal mode (E36).

Furthermore, it is assumed that, as an example of a print execution condition, a threshold value for the number of print jobs stored in the data storage 22 in the power saving mode is set. When the number of print jobs stored in the data storage 22 exceeds the threshold value, the job controller 20J cancels the power saving mode of the multifunction peripheral 10 so that the multifunction peripheral 10 enters the normal mode. In a case where the setting of the threshold value for the number of print jobs is 3, when the number of print jobs stored in the data storage 22 exceeds 3, the job controller 20J cancels the power saving mode of the multifunction peripheral 10 so that the multifunction peripheral 10 enters the normal mode (E36). When the multifunction peripheral 10 enters the normal mode, the job controller 20J executes the print jobs A to C, stored in the data storage 22 (E37). According to this embodiment, print jobs received in the power saving mode and stored in the data storage 22 are collectively executed when a print execution condition is satisfied, and therefore, a period of time for the power saving mode is ensured even under an environment in which print jobs are frequently executed, and power consumption can be reduced. In addition, the administrator user can set appropriate print execution conditions according to use situations of the multifunction peripheral 10. Note that, even when a return condition other than the print execution conditions is satisfied, the job controller 20J may execute a print job received in the power saving mode and stored in the data storage 22.

### Second Embodiment

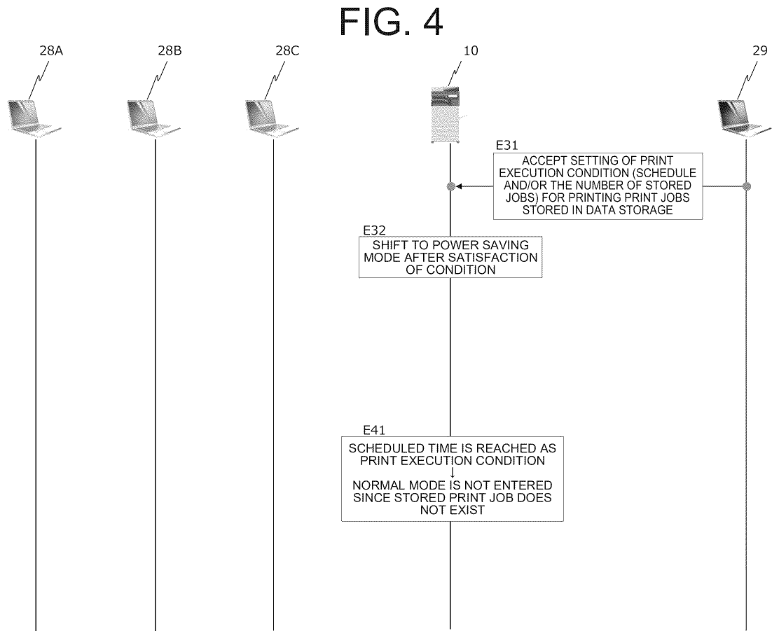

In this embodiment, the job controller 20J does not cancel a power saving mode of the multifunction peripheral 10 when the data storage 22 does not store any print job even in a case where a timing at which a print job stored in the data storage 22 is to be executed is reached as a print execution condition, for example. FIG. 4 is an explanatory diagram illustrating an example of a process performed when the data storage does not store any print job in a case where a set print execution condition is satisfied, according to this embodiment. In FIG. 4, the same events as those in FIG. 3 are denoted by the same reference numerals. Specifically, reference numerals E31 and E32 are the same as those in FIG. 3. Unlike FIG. 3, it is assumed that, after the multifunction peripheral 10 shifts to the power saving mode, time elapses without receiving any print job from the outside, and an execution time of a schedule set as a print execution condition arrives. In this case, since the data storage 22 does not store any print job even though the print execution condition is satisfied, the job controller 20J does not cancel the power saving mode of the multifunction peripheral 10 and therefore, does not cause the multifunction peripheral 10 to enter the normal mode (E41). In this embodiment, the power saving mode can be maintained, when the data storage 22 does not store any print job, that is, when a print job to be executed does not exist, even in a case where the print execution condition for an execution of a print job stored in the data storage 22 is satisfied. Therefore, it is possible to prevent wasteful power consumption in the transition to the normal mode.

Note that a case where storage of a number of print jobs that exceeds a threshold value in the data storage 22 is set as a print execution condition and this print execution condition is satisfied is excepted from this embodiment. This is because, when the print execution condition is satisfied, the data storage 22 stores a print job. Furthermore, when a return condition other than the print execution condition is satisfied, the job controller 20J cancels the power saving mode and enters the normal mode. Note that, when the data storage 22 does not store any print job, the normal mode is entered.

### Third Embodiment

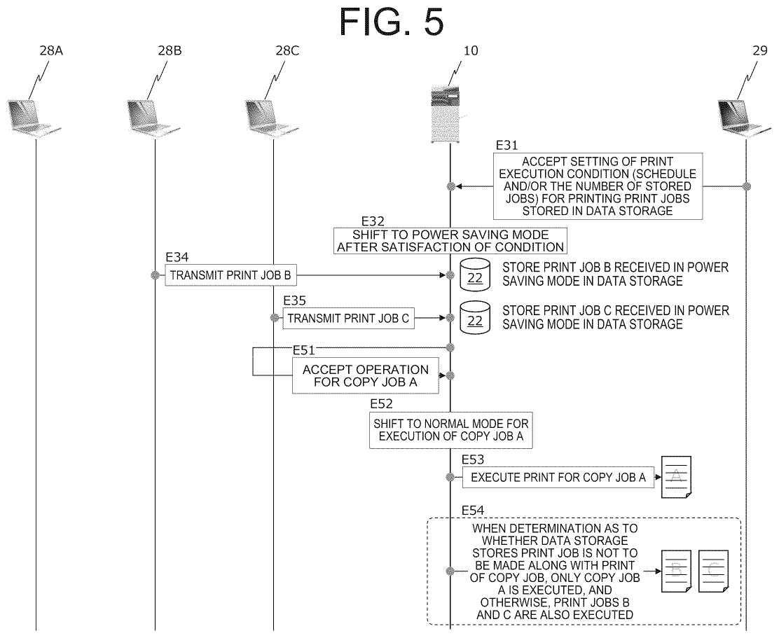

In this embodiment, when a print job based on an operation accepted by an operation acceptor 15 (hereinafter also referred to as a walk-up print job) is to be executed, a print job stored in a data storage 22 is also executed if any. FIG. 5 is an explanatory diagram illustrating an example of a process of additionally executing, when a copy job accepted by the operation acceptor 15 is executed, a print job stored in the data storage 22. In FIG. 5, the same events as those in FIG. 3 are denoted by the same reference numerals. Specifically, reference numerals E31, E32, E34, and E35 are the same as those in FIG. 3. In FIG. 5, a copy job A is executed using the operation acceptor 15, after the print jobs B and C are transmitted to the multifunction peripheral 10 during the power saving mode.

When receiving an operation associated with the copy job A through the operation acceptor 15 serving as the job receiver 23 (E51), the job controller 20J cancels the power saving mode of the multifunction peripheral 10 and causes the multifunction peripheral 10 to enter the normal mode (E52). When receiving an instruction for executing the copy job A through the operation acceptor 15, the job controller 20J causes the document reader 12 serving as the job receiver 23 to read a document and causes the printer 17 to execute printing of the copy job A (E53). Furthermore, when the walk-up print job is to be executed as a print execution condition, the job controller 20J determines whether a setting for additionally executing a print job stored in the data storage 22 if any has been made. When a print execution condition is set such that a print job stored in the data storage 22 is to be executed along with the walk-up print job, the job controller 20J executes the print jobs B and C stored in the data storage 22 (E54).

In this embodiment, as the print execution condition, a setting is performed such that the print job received in the power saving mode and stored in the data storage 22 is executed along with the walk-up print job. According to this embodiment, when the walk-up print job is executed, the print job received in the power saving mode and stored in the data storage 22 can also executed. By this, print jobs received in the power saving mode and stored in the data storage 22 can be executed before the print execution condition is satisfied, while increase in the number of times the normal mode is entered can be suppressed.

Here, when the copy job A received through the operation acceptor 15 and the print job received in the power saving mode and stored in the data storage 22 are executed together, outputs associated with the plurality of jobs are executed on sheet discharge trays. Here, when the multifunction peripheral 10 has the plurality of sheet discharge trays 18 as in this embodiment, outputs of the copy job A and outputs of the print job received in the power saving mode and stored in the data storage 22 may be performed on the different sheet discharge trays 18. Furthermore, in a case where only one sheet discharge tray 18 is provided, the priority may be given to the output of the copy job A. In this case, when a predetermined period of time has elapsed after the output of the copy job A is completed, the print job received in the power saving mode and stored in the data storage 22 is output. Here, the predetermined period of time corresponds to a period of time in which a user who has executed the copy job A by operating the multifunction peripheral 10 is expected to remove an output result from the sheet discharge tray 18. With this configuration, even when a plurality of print jobs are executed together, mixture of output results can be suppressed, and user convenience is not impaired.

Although the copy job is illustrated as an example of the walk-up print job in FIG. 5, the walk-up print job is not limited to this as long as the job is accepted by the operation acceptor 15 and printed by the printer 17. For example, print data with a password received from any of the external information processing apparatuses 28A to 28C is temporarily stored in the data storage 22. When the user selects the print data in a list of print data stored in the data storage 22 using the operation acceptor 15 and inputs the password added to the print data, the job controller 20J executes a print job of the selected print data. The job may also be included in such walk-up print jobs. Furthermore, a job for printing internal data in the multifunction peripheral 10, such as data indicating the total number of used sheets, using the operation acceptor 15, is also included in the walk-up print jobs.

### Fourth Embodiment

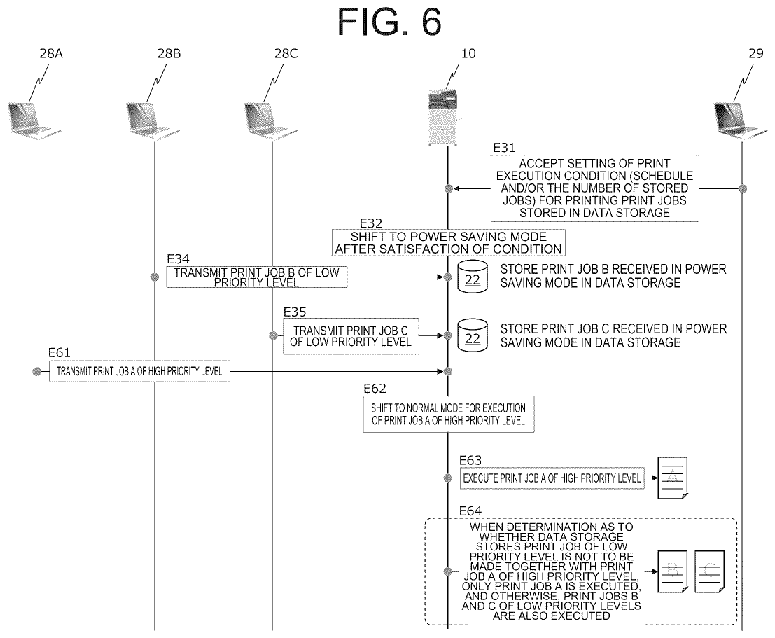

In this embodiment, a priority level is assigned as an attribute to a print job to be received by the multifunction peripheral 10, and the job controller 20J stores, when receiving a print job of a normal priority level (low priority level) in the power saving mode, the print job in the data storage 22 similarly to the first embodiment. On the other hand, when receiving a print job of a high priority level in the power saving mode, the job controller 20J cancels the power saving mode to enter a normal mode so as to execute the print job of the high priority level. In this case, when the data storage 22 stores any print job, the print job is executed together. FIG. 6 is an explanatory diagram illustrating an example of a process of additionally executing, when a print job of a high priority level is executed, a print job of a low priority level stored in the data storage 22. In FIG. 6, the same events as those in FIG. 3 are denoted by the same reference numerals. Specifically, reference numerals E31, E32, E34, and E35 are the same as those in FIG. 3. In FIG. 6, after the print jobs B and C of normal priority levels (low priority levels) are transmitted to the multifunction peripheral 10 in the power saving mode, the print job A of a high priority level is transmitted from the information processing apparatus 28A.

When receiving the print job A of the high priority level (E61), the job controller 20J cancels the power saving mode of the multifunction peripheral 10 so that the normal mode is entered (E62). When the multifunction peripheral 10 enters the normal mode, the job controller 20J executes the print job A of the high priority level so as to cause the printer 17 to perform printing (E63). Furthermore, the job controller 20J determines whether a setting for additionally executing, when the data storage 22 stores a print job of a normal priority level (low priority level), the print job of the normal priority level, when a print job of a high priority level is executed, has been performed as a print execution condition. When the print execution condition is set such that a print job of a low priority level stored in the data storage 22 is to be executed along with a print job of a high priority level, the job controller 20J executes the print jobs B and C stored in the data storage 22 (E64).

According to this embodiment, a print job of a high priority level can be executed before the print execution condition is satisfied even in the power saving mode by assigning an attribute of a priority level to the print job externally received. Furthermore, in this embodiment, a setting is performed such that a print job of a low priority level received in the power saving mode and stored in the data storage 22 is executed along with a print job of a high priority level as the print execution condition. According to this embodiment, when a print execution condition is set such that, when a print job of a high priority level is executed, it is determined whether a print job of a normal priority level has been stored in the data storage 22, the print job stored in the data storage 22 may also be executed. By this, print jobs received in the power saving mode and stored in the data storage 22 can be executed before the print execution condition is satisfied, while increase in the number of times the normal mode is entered can be suppressed.

### Flowchart

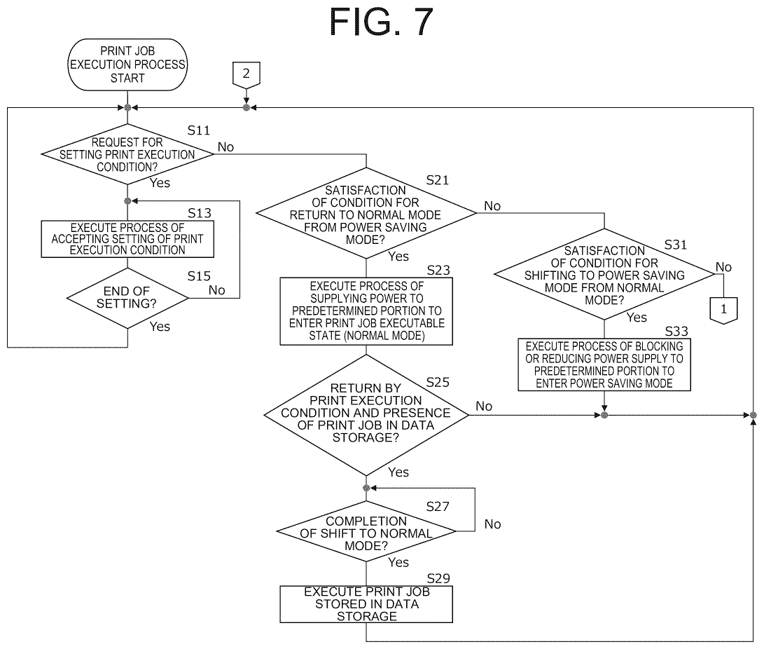

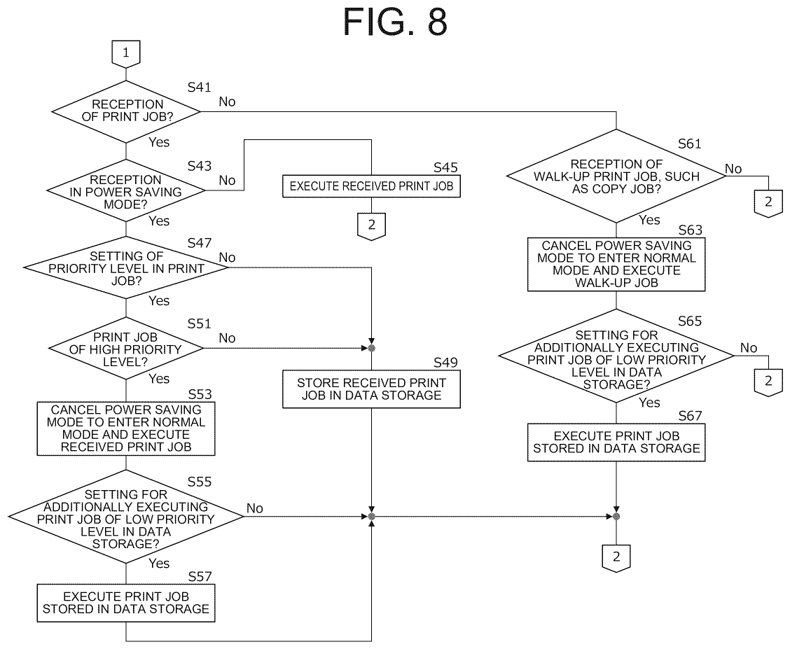

FIGS. 7 and 8 are flowcharts illustrating examples of flows of processes executed by the job controller 20J according to the embodiments illustrated in FIGS. 3 to 6. The flows of the processes will be described with reference to the flowcharts. As illustrated in FIG. 7, the job controller 20J determines whether a request for setting a print execution condition has been received through the operation acceptor 15 or the communicator 21 (step S11). When the request for setting a print execution condition is received (Yes in step S11), a process is executed in accordance with contents of the setting of the received print execution condition (step S13), and the setting is stored in the setting storage 20S. When a plurality of setting requests are issued, the process is executed for each request (a loop of returning to step S13 via No in step S15). When all the processes for the setting requests are terminated (Yes in step S15), the process returns to step S11 described above.

Furthermore, the job controller 20J determines whether a condition for shift to the normal mode from the power saving mode is satisfied (step S21). When the condition for shift to the normal mode is satisfied (Yes in step S21), the job controller 20J supplies power to a predetermined portion of the multifunction peripheral 10 where the power supply is blocked or reduced in the power saving mode, and causes the multifunction peripheral 10 to enter the normal mode in which the multifunction peripheral 10 can execute a print job (step S23). For example, power is supplied to a fusing device, a display section, and the like, not illustrated in FIG. 2. Furthermore, the job controller 20J determines whether the data storage 22 stores any print job received in the power saving mode (step S25). When the data storage 22 stores a print job (Yes in step S25), the job controller 20J waits for completion of shift to the normal mode (step S27), and thereafter, executes the print job stored in the data storage 22 (step S29). Then the process returns to step S11 described above.

Furthermore, the job controller 20J determines whether a condition for shift to the power saving mode from the normal mode is satisfied (step S31 via No in step S11 and No in step S21). When the condition for shift to the power saving mode from the normal mode is satisfied (Yes in step S31), the job controller 20J blocks or reduces the power supply to a predetermined portion (such as the fusing device or the display section) of the multifunction peripheral 10 and causes the multifunction peripheral 10 to enter the power saving mode (step S33). Then the process returns to step S11 described above.

Furthermore, the job controller 20J determines whether a print job has been received through the communicator 21 (step S41 of FIG. 7 via No in step S11, No in step S21, and No in step S31 of FIG. 6). When a print job has been received (Yes in step S41), the job controller 20J determines whether the reception is performed in the power saving mode (step S43). When the reception is not performed in the power saving mode, that is, the reception is performed in the normal mode (No in step S43), the received print job is executed (step S45). Then, the process returns to step S11 of FIG. 6.

On the other hand, when the reception is performed in the power saving mode (Yes in step S43), the job controller 20J determines whether the print job has an attribute of a priority level assigned thereto (step S47). When the print job does not have an attribute of a priority level and different processes according to priority levels are not required to be performed on individual received print jobs (No in step S47), the job controller 20J stores the target print job received in the power saving mode in the data storage 22 (step S49) and returns the process to step S11 of FIG. 6. Furthermore, when the print job has an attribute of a priority level assigned thereto (Yes in step S47), the job controller 20J determines whether the received print job has a high priority level or a normal priority level (low priority level) (step S51). In a case of the normal priority level (low priority level) (No in step S51), the target print job received in the power saving mode is stored in the data storage 22 (step S49) before the process returns to step S11 of FIG. 6.

On the other hand, when the received print job has a high priority level (Yes in step S51), the job controller 20J cancels the power saving mode to enter the normal mode and executes the print job of the high priority level (step S53). Furthermore, the job controller 20J refers to the setting storage 20S and determines whether a print execution condition for additionally executing a print job of a low priority level stored in the data storage 22 when the print job of the high priority level is executed has been set (step S55). When such a print execution condition is not set (No in step S55), the process returns to step S11 of FIG. 6. On the other hand, when a setting is performed such that a print job of a low priority level is to be additionally executed, the job controller 20J executes the print job of the normal priority level stored in the data storage 22 together with execution of the print job of the high priority level (step S57). Then the process returns to step S11 of FIG. 6.

Furthermore, the job controller 20J determines whether a walk-up print job has been received (step S61 via No in step S11, No in step S21 and No in step S31 of FIG. 6, and No in step S41 of FIG. 7). When a walk-up print job has not been received (No in step S61), the process returns to step S11 of FIG. 6. On the other hand, when the walk-up print job is received (Yes in step S61), the job controller 20J cancels the power saving mode to enter the normal mode and executes the received walk-up print job (step S63).

Furthermore, the job controller 20J refers to the setting storage 20S and determines whether a print execution condition for additionally executing a print job stored in the data storage 22 when the walk-up print job is executed has been set (step S65). When such a print execution condition is not set (No in step S65), the process returns to step S11 of FIG. 6. On the other hand, when a setting is performed such that a print job stored in the data storage 22 is to be additionally executed and such a job exists as a target, the job controller 20J additionally executes the target print job (step S67). Then the process returns to step S11 of FIG. 6. The above describes the flow of the process executed by the job controller 20J in the embodiments illustrated in FIGS. 3 to 6.

### Other Embodiments

As a preferred embodiment of the present disclosure, the job controller 20J stores, when externally receiving a print job in the power saving mode, the print job in the data storage 22 and executes the print job stored in the data storage 22 when a planned timing set in a schedule of the print execution condition is reached. When a print job is externally received in the power saving mode, information associated with the planned timing is supplied to a transmission source of the print job. According to this embodiment, when a print job is received in the power saving mode and is not executed until a planned timing is reached, information associated with the planned timing for printing is supplied to a transmission source of the print job. Accordingly, the user who has transmitted the print job can recognize the timing when the print job is planned to be executed.

Furthermore, when the planned timing set in the schedule of the print execution condition is reached and the print job stored in the data storage 22 is executed, the job controller 20J may notify the transmission source of the execution. Accordingly, the user who has transmitted the print job can recognize that the print job is planned to be executed when receiving a notification indicating the reach of the timing at which the print job is executed.

Furthermore, the job controller 20J may accept, in the following unit, a setting for a print execution condition associated with whether a print job stored in the data storage 22 is to be executed when the planned timing which has been set in the schedule of the print execution condition is reached. For example, the job controller 20J may accept the setting of a print execution condition for each user authenticated by the user authenticator 20A. In addition, the user authenticator 20A may authenticate each user, and the authenticated user may have an attribute indicating a group including the user and a group not including the user. Then the setting of the print execution condition described above may be accepted in a unit of a common group to which a plurality of authenticated users belong. According to this embodiment, by accepting the setting of the print execution condition associated with the planned timing for each user or each group, confusion with other users, other groups, or other types of print jobs can hardly occur.

It should be understood that the present disclosure includes combinations of any of the foregoing embodiments. Various modifications may be made to the present disclosure in addition to the foregoing embodiments. Such modifications should not be construed as falling outside the scope of the present disclosure. The present disclosure is embodied by the claims and their equivalents, and should embrace all modifications that fall within the scope of the present disclosure.

What is claimed is:

1. An image forming apparatus, comprising:
a printer that performs printing;
a job receiver that receives a print job to be performed using the printer;
a data storage that stores the print job when the print job is externally received in a power saving mode that is a state in which power consumption is less than a normal mode that is a state in which the printing is executable; and
one or more controllers that execute the print job after entering the normal mode from the power saving mode when one or both of reach of a planned timing and storage of at least a predetermined number of the print jobs in the data storage is satisfied, as a predetermined print execution condition.

2. The image forming apparatus according to claim 1, wherein, when the execution of the print job is terminated, the one or more controllers perform shift from the normal mode to the power saving mode.

3. The image forming apparatus according to claim 1, wherein, even in a case where the planned timing is reached, the one or more controllers do not perform shift from the power saving mode to the normal mode when the data storage does not store the print job.

4. The image forming apparatus according to claim 1, wherein
the job receiver includes a communicator that externally receives data on the print job and an operation acceptor that accepts an operation associated with the print job, and
in a case where the print job is executed based on an operation accepted via the operation acceptor, the one or more controllers perform shift to the normal mode in response to the acceptance of the operation and execute the print job.

5. The image forming apparatus according to claim 4, wherein
a setting is further included such that, in a case where the data storage stores an other print job when the print job is executed based on the operation accepted via the operation acceptor is executed, the other print job stored in the data storage is also executed, and
if the setting is performed, the one or more controllers additionally execute the print job stored in the data storage along with the execution of the print job received via the operation acceptor even when the print execution condition is not satisfied.

6. The image forming apparatus according to claim 4, further comprising:
a document reader that reads a document, wherein
the print job received via the operation acceptor includes a copy job for printing data read by the document reader, and
when the print execution condition is set such that the print job stored in the data storage is additionally executed when the copy job is executed, the one or more controllers determine whether the data storage stores the print job and executes the print job when the determination is affirmative.

7. The image forming apparatus according to claim 1, wherein
the print job externally received has an attribute of a priority level, and
the one or more controllers store the print job of a normal priority level in the data storage when the print job of the normal priority level is received in the power saving mode, and executes the print job of a high priority level after the normal mode is entered when the print job of the high priority level is received in the power saving mode.

8. The image forming apparatus according to claim 7, wherein
the print execution condition further includes a setting performed such that, in a case where the data storage stores the print job of the normal priority level when the print job of the high priority level is executed, the print job of the normal priority level is also executed, and
in a case where the print execution condition is set such that the print job of the normal priority level stored in the data storage is additionally executed when the print job of the high priority level is executed, the one or more controllers determine whether the data storage stores the print job of the normal priority level and executes the print job of the normal priority level when the determination is affirmative.

9. The image forming apparatus according to claim 1, wherein
the one or more controllers execute the print job stored in the data storage when the print execution condition is satisfied since the planned timing is reached, and
when the print job is received, information on the planned timing at which the print job is to be executed is supplied to a transmission source of the print job.

10. The image forming apparatus according to claim 9, wherein, when the print job is executed at the planned timing, the one or more controllers notify the transmission source of the execution of the print job.

11. The image forming apparatus according to claim 1, wherein, the one or more controllers accept a setting of a print execution condition associated with the planned timing for each user or each group including a plurality of users.

12. An image forming method employed in a processor controlling an image forming apparatus, the processor comprising:
receiving at least a print job for performing printing;
storing the print job in a data storage when the print job is externally received in a power saving mode that is a state in which power consumption is less than a normal mode that is a state in which the printing is executable; and
executing the print job after entering the normal mode from the power saving mode when a print execution condition including one or both of reach of a planned timing and storage of at least a predetermined number of the print jobs in the data storage, is satisfied, as a predetermined condition.
